(19) United States
(12) Patent Application Publication
(10) Pub. No.: US 2023/0302810 A1
(43) Pub. Date: Sep. 28, 2023

(54) LIQUID CARTRIDGE INCLUDING PLATE HAVING ATTENUATING SURFACE CONFIGURED TO ATTENUATE INCIDENT LIGHT

(71) Applicant: BROTHER KOGYO KABUSHIKI KAISHA, Nagoya (JP)

(72) Inventors: Satoru OKI, Nagoya (JP); Naoya OKAZAKI, Hashima (JP); Masahiro HAYASHI, Nishio (JP); Nanami ABE, Niigata (JP); Yuma TANABE, Nagoya (JP); Yuji FUKUTA, Nagoya (JP)

(73) Assignee: BROTHER KOGYO KABUSHIKI KAISHA, Nagoya (JP)

(21) Appl. No.: 18/183,728

(22) Filed: Mar. 14, 2023

(30) Foreign Application Priority Data
Mar. 28, 2022 (JP) 2022-051935

(51) Int. Cl. B41J 2/175

(52) U.S. Cl. CPC B41J 2/17543; B41J 2/1752; B41J 2/17566; B41J 2002/17573

(57) ABSTRACT

A liquid cartridge attachable to a case includes: a cartridge body; a liquid supply portion; an electronic board including an electrode group; a plate having an attenuating surface configured to attenuate incident light; and a positioning member having a positioning surface for positioning the liquid cartridge attached to the case. When the liquid cartridge is attached to the case, the plate is configured to be detected by an optical sensor configured to emit light traveling in the left-right direction. The attenuating surface has a detection area immovable relative to the cartridge body. The light emitted from the optical sensor is configured to be incident on the detection area when the liquid cartridge is attached to the case. The detection area is positioned further rearward and upward than the electrode group and positioned further frontward and downward than the positioning surface.

### REFERENCE TO RELATED APPLICATIONS

This application claims priority from Japanese Patent Application No. 2022-051935 filed on Mar. 28, 2022. The entire content of the priority application is incorporated herein by reference.

### BACKGROUND ART

Conventionally, there has been known an inkjet recording apparatus configured to record an image on a recording medium by ejecting ink stored in an ink cartridge through nozzles. Whenever ink stored in an ink cartridge runs out, a new ink cartridge is attached to such an inkjet recording apparatus.

There has also been known an ink cartridge including an inner frame defining a storage chamber storing ink therein, and a cover covering the inner frame. For example, a prior art describes an ink cartridge including a cartridge body and a bracket. The cartridge body defines an ink chamber storing ink therein, and the bracket is assembled to the cartridge body to constitute an outer shell of the ink cartridge.

The above ink cartridge has a front wall on which an ink supply portion is provided. During attachment of the ink cartridge to a printer, an ink needle of the printer is inserted into the ink supply portion, thereby providing positioning of the ink cartridge relative to the printer.

### DESCRIPTION

In order to avoid image recording operation in the printer when the ink cartridge is not attached thereto, the printer is configured to determine whether or not the ink cartridge has been attached. Also, since the ink cartridge needs to have a shape compatible with the printer or to store ink compatible with the printer, the printer may determine whether or not the ink cartridge compatible therewith has been attached.

For determining whether or not the ink cartridge compatible with the printer has been attached, it is conceivable that determination is made by reading electronic information stored in an electronic board mounted on the ink cartridge attached to the printer. However, there is a likelihood that information stored in the electronic board be lost due to static electricity or impact imparted thereon, or that short-circuit or contact failure may occur when ink and the like is adhered to the electronic board, for example. In this case, the ink cartridge on which this electronic board is mounted is determined to be unusable despite the fact that the ink cartridge is compatible with the printer.

As another means, it is also conceivable that the printer includes an optical sensor, and the optical sensor is configured to detect presence or absence of a detection portion such as a plate provided in advance at a prescribed position in the ink cartridge. In this case, the printer can detect the plate using the optical sensor as long as the plate does not get damaged physically. However, the ink cartridge in its attached state is not always accurately positioned relative to the printer due to looseness, and the presence of the plate may not be detected by the optical sensor if the plate is displaced.

In view of the foregoing, it is an object of the present disclosure to provide a liquid cartridge whose attached state can be certainly detected.

In order to attain the above and other object, the present disclosure provides a liquid cartridge attachable to a case in an attached posture. The liquid cartridge includes: a cartridge body; a liquid supply portion; an electronic board; a plate; and a positioning member. The cartridge body defines therein a liquid storage chamber. The cartridge body has a front surface and a top surface. The liquid supply portion is provided at the front surface of the cartridge body and is configured to supply liquid stored in the liquid storage chamber to an outside of the cartridge body. The electronic board is provided at the top surface of the cartridge body and includes an electrode group including at least three electrodes. The at least three electrodes face upward in the attached posture. The plate is provided at the top surface of the cartridge body. The plate is positioned further rearward relative to the electrode group and protrudes further upward relative to the electrode group in the attached posture. The plate has an attenuating surface configured to attenuate incident light traveling in a left-right direction perpendicular to a front-rear direction. The positioning member is provided at the top surface of the cartridge body. The positioning member is positioned further rearward relative to the plate and protrudes upward from the top surface of the cartridge body in the attached posture. The positioning member has a positioning surface for positioning the liquid cartridge attached to the case in the front-rear direction. When the liquid cartridge is attached to the case, the plate is configured to be detected by an optical sensor configured to emit light traveling in the left-right direction. The attenuating surface has a detection area immovable relative to the cartridge body. The light emitted from the optical sensor is configured to be incident on the detection area when the liquid cartridge is attached to the case. The detection area is positioned further rearward and upward relative to the electrode group in the attached posture and is positioned further frontward and downward relative to the positioning surface in the attached posture.

In the above structure, the electrodes in the electrode group and the attenuating surface are positioned at the top surface of the cartridge body. Accordingly, ink is hard to get attached to the electrodes and the attenuating surface even if the ink is leaked through the liquid supply portion. Further, since the attenuating surface is positioned closer to the liquid supply portion than the positioning surface is to the liquid supply portion, the detection area in the attenuating surface can be certainly detected by the optical sensor even if the cartridge body is displaced in an up-down direction or the left-right direction when the liquid cartridge is attached to the case. Still further, a detection portion that can be detected by the optical sensor can be provided between the electrodes and the plate.

According to another aspect, the present disclosure also provides a liquid cartridge including: a cartridge body; a liquid supply portion; an electronic board; a plate; and a positioning surface. The cartridge body defines therein a liquid storage chamber. The cartridge body has a front side, a rear side provided opposite the front side in a front-rear direction, an upper side, and a lower side provided opposite the upper side in an up-down direction which is perpendicular to the front-rear direction. The liquid supply portion is provided at the front side of the cartridge body in the front-rear direction and is configured to supply liquid stored in the liquid storage chamber to an outside of the cartridge body. The electronic board is provided at the upper side of the cartridge body in the up-down direction and includes an electrode group including at least three electrodes. The at least three electrodes face upward in the up-down direction. The plate is configured to attenuate incident light traveling in a left-right direction which is perpendicular to the front-rear direction. The plate is positioned further rearward relative to the electrode group in the front-rear direction and has an upper end protruding further upward relative to the electrode group in the up-down direction. The positioning surface is provided at the upper side of the cartridge body. The positioning surface is positioned further rearward relative to the plate in the front-rear direction and in the up-down direction. The upper end of the plate is positioned further rearward and upward relative to the electrode group and positioned further frontward and downward relative to the positioning surface. The plate is immovable in the front-rear direction and in the up-down direction relative to the electrode group.

Even in the above structure, the electrodes in the electrode group and the plate are positioned at the upper side of the cartridge body in the up-down direction. Accordingly, ink is hard to get attached to the electrodes and the plate even if the ink is leaked through the liquid supply portion.

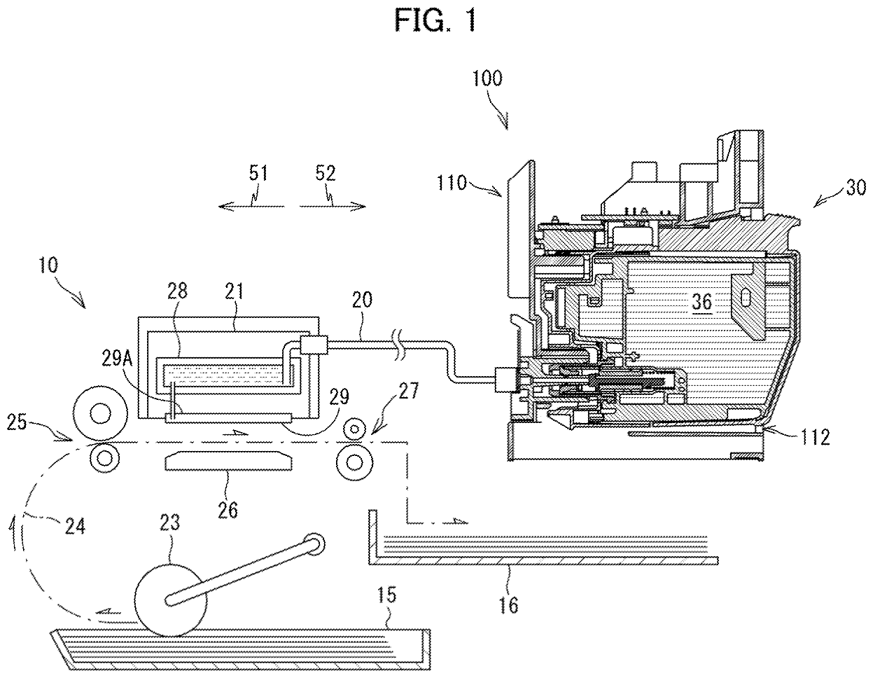

FIG. 1 is a schematic cross-sectional view conceptually illustrating an internal configuration of a printer including a cartridge-attachment section.

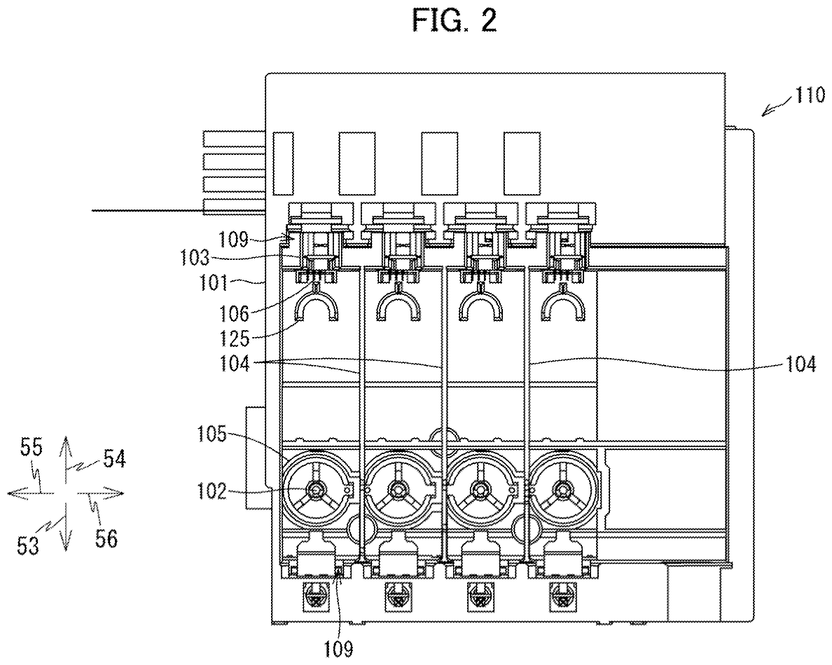

FIG. 2 is a view illustrating an external appearance of the cartridge-attachment section.

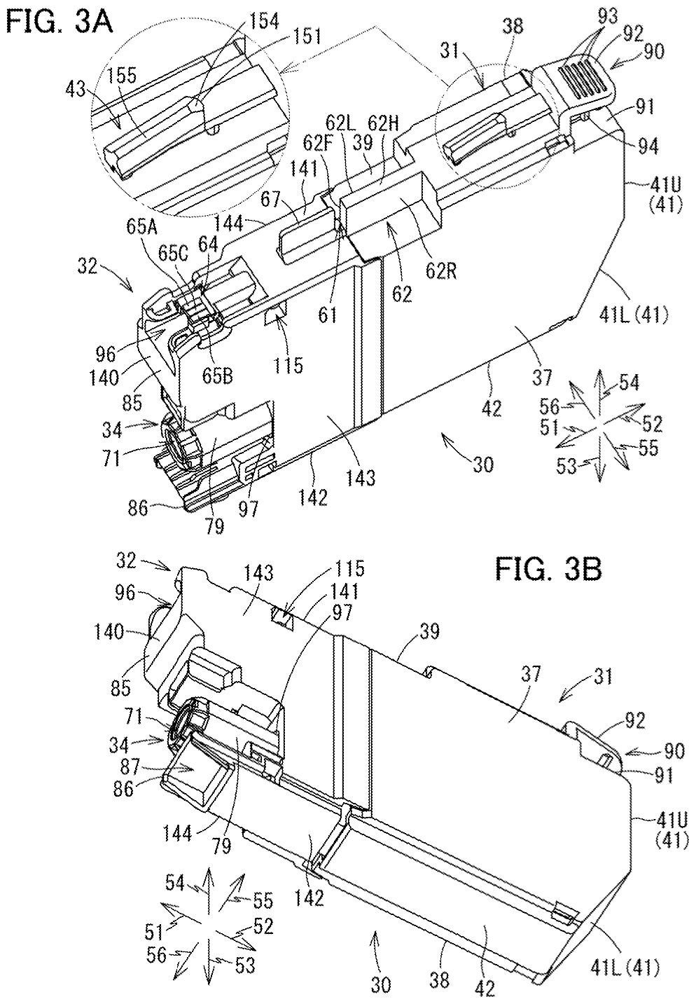

FIG. 3A is a perspective view illustrating an external appearance of an ink cartridge as viewed from a perspective frontward and upward thereof.

FIG. 3B is a perspective view illustrating the external appearance of the ink cartridge as viewed from a perspective frontward and downward thereof.

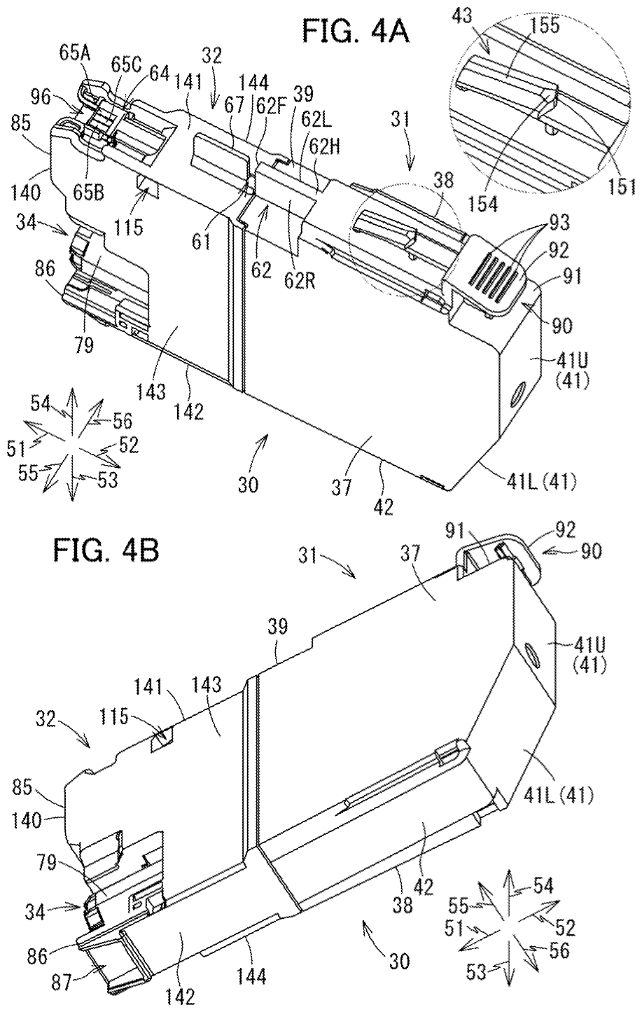

FIG. 4A is a perspective view illustrating the external appearance of the ink cartridge as viewed from a perspective rearward and upward thereof.

FIG. 4B is a perspective view illustrating the external appearance of the ink cartridge as viewed from a perspective rearward and downward thereof.

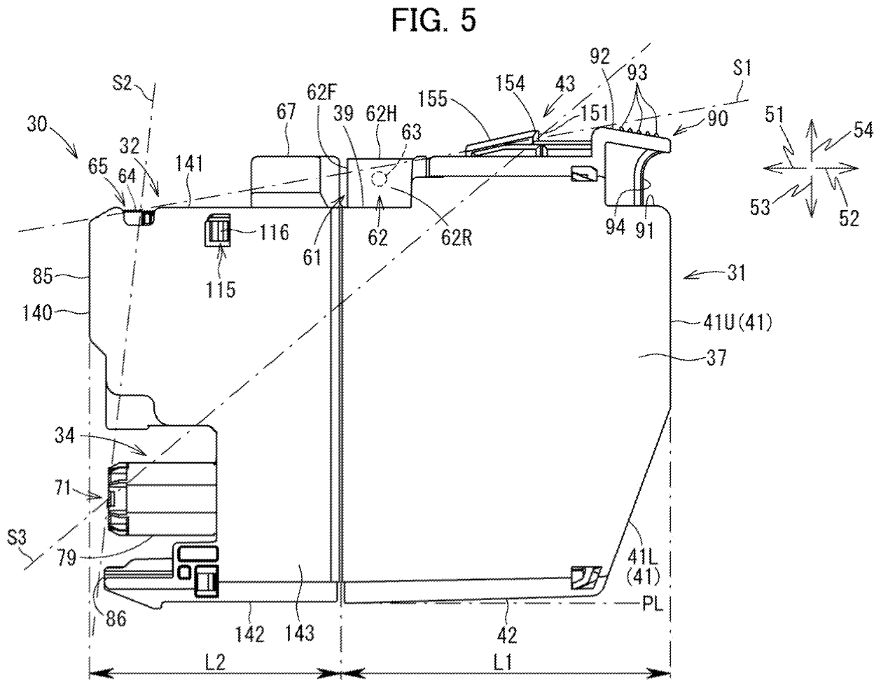

FIG. 5 is a side view of the ink cartridge.

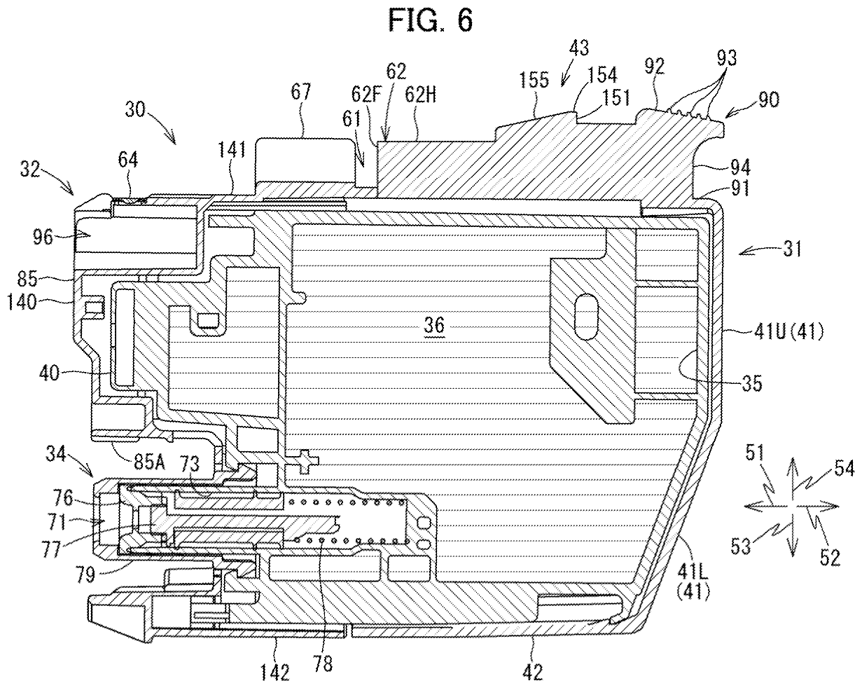

FIG. 6 is a vertical cross-sectional view illustrating an internal configuration of the ink cartridge.

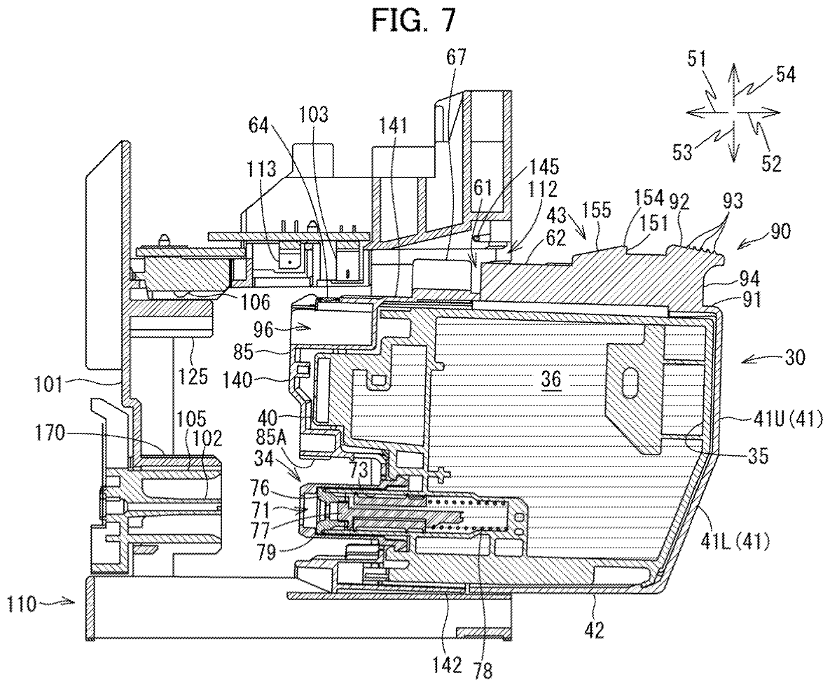

FIG. 7 is a vertical cross-sectional view of the ink cartridge and the cartridge-attachment section, and particularly illustrating a state where the ink cartridge starts to be inserted into the cartridge-attachment section.

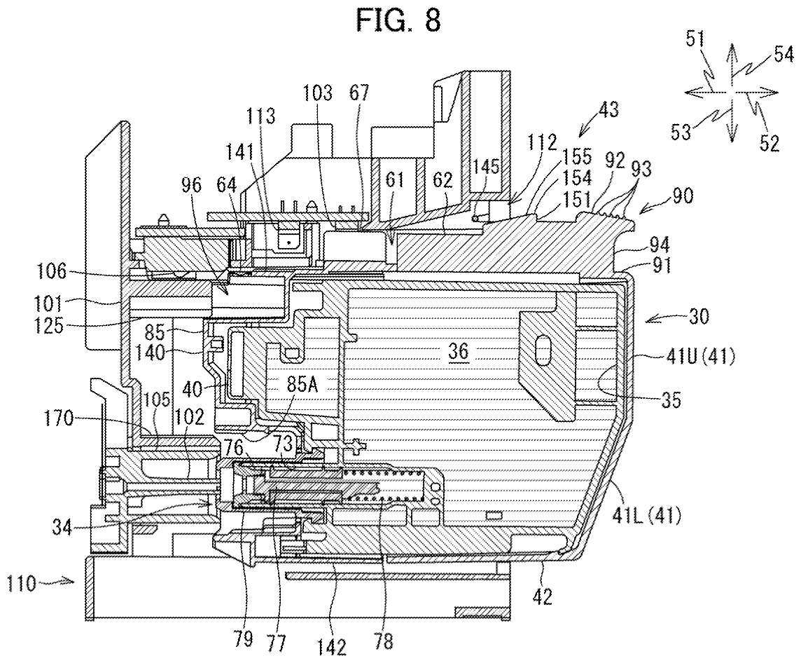

FIG. 8 is a vertical cross-sectional view of the ink cartridge and the cartridge-attachment section, and particularly illustrating a state where an ink supply portion starts to enter a guide portion, and a rod starts to enter a recessed portion of a front cover.

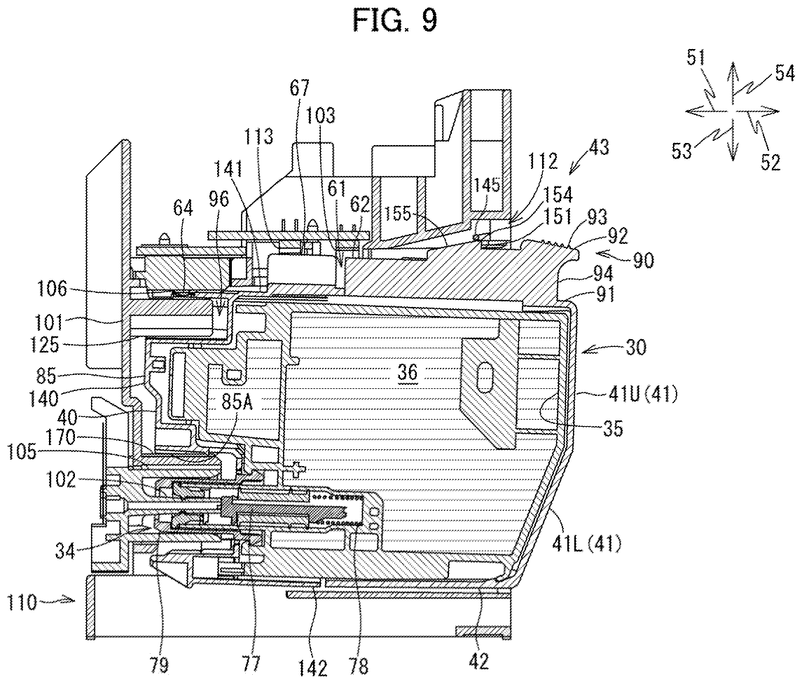

FIG. 9 is a vertical cross-sectional view of the ink cartridge and the cartridge-attachment section, and particularly illustrating a state where an ink needle is inserted through an ink supply port of the ink supply portion.

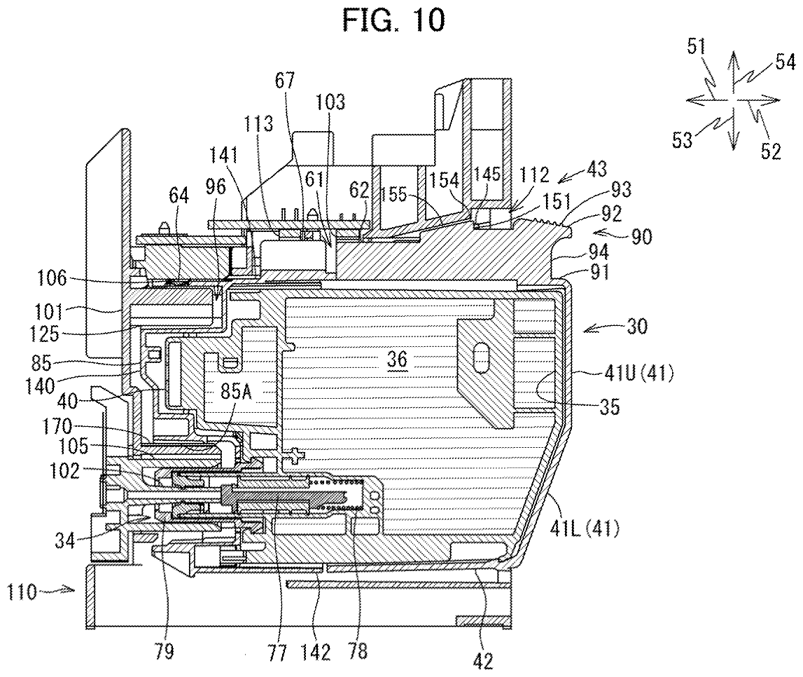

FIG. 10 is a vertical cross-sectional view of the ink cartridge and the cartridge-attachment section, and illustrating a state where the ink cartridge is positioned relative to the cartridge-attachment section.

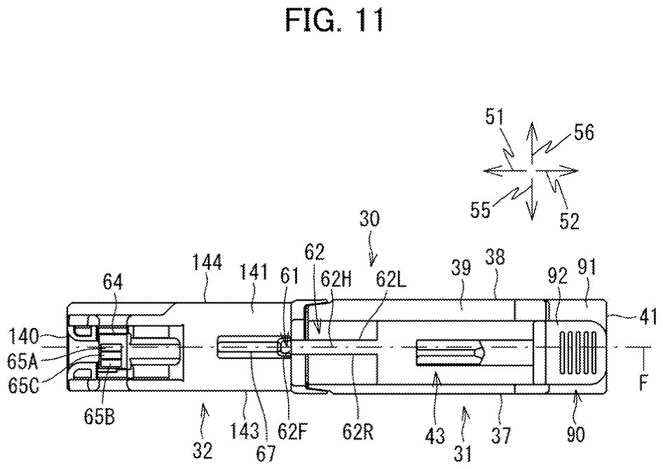

FIG. 11 is a top view of the ink cartridge.

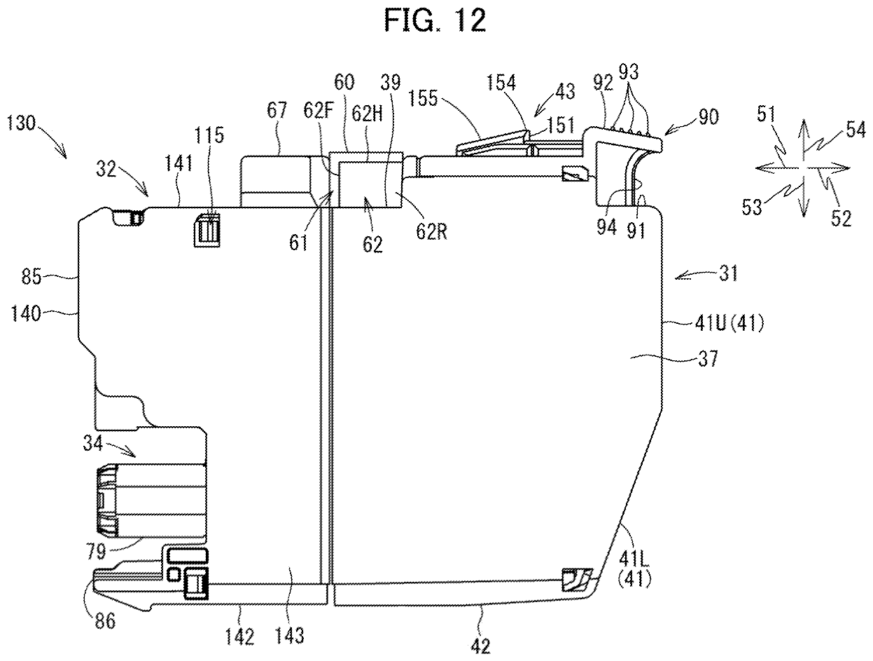

FIG. 12 is a side view of an ink cartridge.

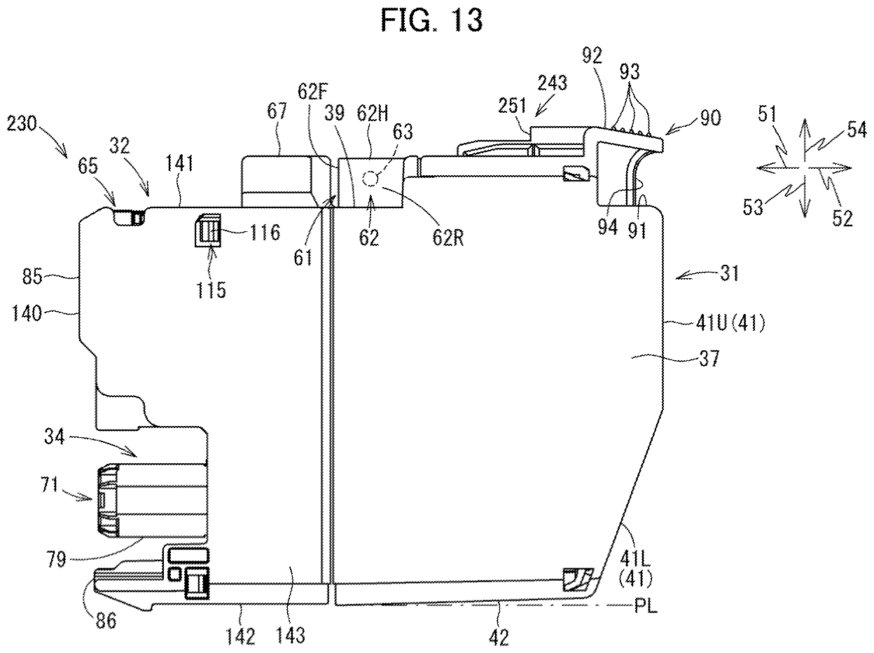

FIG. 13 is a side view of an ink cartridge.

Hereinafter, one embodiment of the present disclosure will be described in detail while referring to accompanying drawings. It would be apparent to those skilled in the art that the embodiment described below is merely an example of the present disclosure and many modifications and variations may be made thereto.

In the following description, a frontward direction 51 is defined as a direction in which an ink cartridge 30 according to the embodiment is inserted into a cartridge-attachment section 110, and a rearward direction 52 is defined as a direction opposite the frontward direction 51, that is, a direction in which the ink cartridge 30 is extracted from the cartridge-attachment section 110. In the present embodiment, the frontward direction 51 and the rearward direction 52 coincide with a horizontal direction. However, the frontward direction 51 and the rearward direction 52 need not coincide with the horizontal direction.

Further, a downward direction 53 is defined as a direction coincident with the gravitational direction, and an upward direction 54 is defined as a direction opposite the downward direction 53 (the gravitational direction). Further, a rightward direction 55 and a leftward direction 56 are defined as directions perpendicular to both the frontward direction 51 and the downward direction 53. More specifically, in a state where the ink cartridge 30 has been completely received in the cartridge-attachment section 110, i.e., in a state where the ink cartridge 30 is in an attached posture (an attached state of the ink cartridge 30), and when a user views the ink cartridge 30 from its front side, the rightward direction 55 is a direction toward the right and the leftward direction 56 is a direction toward the left.

In the following description, whenever appropriate, the frontward direction 51 and the rearward direction 52 will be collectively referred to as a front-rear direction 51 and 52, the upward direction 54 and the downward direction 53 will be collectively referred to as an up-down direction 53 and 54, and the rightward direction 55 and the leftward direction 56 will be collectively referred to as a left-right direction 55 and 56.

Further, in this specification, “facing frontward” includes facing in a direction including a frontward component, “facing rearward” includes facing in a direction including a rearward component, “facing downward” includes facing in a direction including a downward component, and “facing upward” includes facing in a direction including an upward component. For example, “a front surface faces frontward” denotes that the front surface may face in a frontward direction, or the front surface may face in a direction inclined relative to the frontward direction.

<Overview of Printer 10>

A printer 10 illustrated in FIG. 1 is configured to form an image by selectively ejecting ink droplets onto a sheet based on an inkjet recording system. The printer 10 includes a recording head 21, an ink-supplying device 100, and ink tubes 20 connecting the recording head 21 and the ink-supplying device 100 to each other. The ink-supplying device 100 includes the cartridge-attachment section 110. The cartridge-attachment section 110 can detachably receive the ink cartridges 30 therein.

The cartridge-attachment section 110 has a surface formed with an opening 112. The ink cartridges 30 can be inserted into the cartridge-attachment section 110 in the frontward direction 51 through the opening 112, and extracted from the cartridge-attachment section 110 in the rearward direction 52 through the opening 112.

The ink cartridges 30 store therein ink that can be used by the printer 10 for printing. The ink cartridge 30 is connected to the recording head 21 through the corresponding ink tube 20 when the ink cartridge 30 has been completely mounted in the cartridge-attachment section 110.

The recording head 21 includes a sub tank 28 for temporarily storing ink supplied from the ink cartridge 30 through the ink tube 20. The recording head 21 also includes a plurality of nozzles 29 through which the ink supplied from the sub tank 28 is selectively ejected in accordance with the inkjet recording system. More specifically, the recording head 21 includes a head control board (not illustrated), and piezoelectric elements 29A each corresponding to one of the nozzles 29. The head control board is configured to apply drive voltages to the selected one(s) of the piezoelectric elements 29A so that ink is ejected through the nozzles 29 corresponding thereto. In this way, the recording head 21 is configured to consume the ink stored in the ink cartridge 30 attached to the cartridge-attachment section 110.

The printer 10 also includes a sheet tray 15, a sheet feeding roller 23, a conveying path 24, a pair of conveying rollers 25, a platen 26, a pair of discharge rollers 27, and a discharge tray 16. A sheet(s) accommodated in the sheet tray 15 is fed therefrom by the sheet feeding roller 23 to the conveying path 24, and then conveyed by the conveying rollers 25 onto the platen 26. The recording head 21 ejects ink onto the sheet as the sheet moves over the platen 26, thereby recording an image on the sheet. The sheet that has passed the platen 26 is then discharged by the discharge rollers 27 onto the discharge tray 16 disposed at a downstream end of the conveying path 24.

<Ink-Supplying Device 100>

The ink-supplying device 100 is provided in the printer 10, as illustrated in FIG. 1. The ink-supplying device 100 functions to supply ink to the recording head 21. As described above, the ink-supplying device 100 includes the cartridge-attachment section 110 for detachably receive the ink cartridge 30 therein. FIG. 1 illustrates a state where the ink cartridge 30 has been completely received in the cartridge-attachment section 110. In other words, the ink cartridge 30 is in the attached state in FIG. 1.

<Cartridge-Attachment Section 110>

As illustrated in FIGS. 2 and 7, the cartridge-attachment section 110 includes a case 101, four ink needles 102, four optical sensors 103, four optical sensors 113, four sets of three contacts 106, four rods 125, and a locking portion 145. In the cartridge-attachment section 110, four kinds of ink cartridges 30 corresponding to four colors of cyan, magenta, yellow and black are detachably mountable. Accordingly, one ink needle 102, one optical sensor 103, one optical sensor 113, one set of three contacts 106, and one rod 125 are provided for each of the four kinds of ink cartridges 30.

<Case 101>

The case 101 constitutes a housing of the cartridge-attachment section 110. As illustrated in FIGS. 2 and 7, the case 101 has a box-like shape defining an internal space therein and has an open end serving as the opening 112. Specifically, the case 101 includes a top wall defining a ceiling of the internal space, a bottom wall defining a bottom of the internal space, and an end wall connecting the top wall and the bottom wall to each other. The opening 112 of the case 101 is positioned opposite the end wall in the front-rear direction 51 and 52. The opening 112 can be exposed to a surface (a user-interface surface) that a user faces when using the printer 10.

The four kinds of ink cartridges 30 can be inserted into and removed from the case 101 through the opening 112. In the case 101, each of the top wall and the bottom wall is formed with four guide grooves 109 for guiding insertion and removal of the ink cartridges 30. Specifically, when the ink cartridge 30 is inserted into and removed from the case 101 through the opening 112, upper and lower ends of the ink cartridge 30 are received in the corresponding guide grooves 109 in the top wall and the bottom wall, respectively, and guided thereby in the front-rear direction 51 and 52, as illustrated in FIG. 7. Further, the case 101 also includes three plates 104 that partition the internal space into four individual spaces each elongated in the up-down direction 53 and 54. Each of the four ink cartridges 30 can be mounted in a corresponding one of the four spaces defined in the case 101 by the plates 104.

<Ink Needles 102>

Each of the ink needles 102 is formed of resin and has a generally tubular shape. As illustrated in FIG. 7, the ink needles 102 are disposed on a lower end portion of the end wall constituting the case 101. Specifically, each of the ink needles 102 is arranged at a position corresponding to an ink supply portion 34 (described later) of the corresponding ink cartridge 30 mounted in the cartridge-attachment section 110. Each of the ink needles 102 protrudes rearward from the end wall of the case 101.

Four cylindrical-shaped guide portions 105 are provided on the end wall to surround the corresponding ink needles 102. Each of the guide portions 105 protrudes rearward from the end wall to have a protruding end that is open rearward. Each of the ink needles 102 is positioned at a diametrical center of the corresponding guide portion 105. Each of the guide portions 105 is shaped to allow the ink supply portion 34 of the corresponding ink cartridge 30 to be inserted therein.

During insertion of the ink cartridge 30 into the cartridge-attachment section 110 in the frontward direction 51, i.e., in the course of action for bringing the ink cartridge 30 into an attached position where the ink cartridge 30 is attached to the cartridge-attachment section 110, the ink supply portion 34 of the ink cartridge 30 enters the corresponding guide portion 105 (see FIG. 9). As the ink cartridge 30 is further inserted frontward, the ink needle 102 enters an ink supply port 71 of the ink supply portion 34. The ink needle 102 is thus connected to the ink supply portion 34, which provides positioning of the ink supply portion 34 relative to the cartridge-attachment section 110.

Since the ink needle 102 and the ink supply portion 34 are in communication with each other, ink stored in an ink chamber 36 formed in the ink cartridge 30 is allowed to flow into the ink tube 20 connected to the ink needle 102 through an internal space defined in a tubular wall 73 in the ink supply portion 34 and an inner space defined in the ink needle 102. Note that the ink needle 102 may have a flat-shaped tip end or a pointed tip end.

<Locking Portion 145>

As illustrated in FIG. 7, the locking portion 145 extends in the left-right direction 55 and 56 at a position near the top wall of the case 101 and near the opening 112. The locking portion 145 is a rod-shaped member extending in the left-right direction 55 and 56. For example, the locking portion 145 is a columnar member made of meal. Left and right ends of the locking portion 145 are respectively fixed to left and right side walls constituting the case 101. Hence, the locking portion 145 is immovable relative to the case 101 and does not make any relative movement (such as pivotal movement) to the case 101. The locking portion 145 extends in the left-right direction 55 and 56 across the four individual spaces defined in the case 101. In each of the four spaces for receiving corresponding one of the ink cartridges 30, the locking portion 145 is accessible from below and from frontward by the ink cartridge 30 inserted in the space of the case 101 due to a space available around the locking portion 145.

The locking portion 145 functions to hold the ink cartridge 30 in its attached position in the cartridge-attachment section 110. Specifically, the ink cartridge 30 inserted in the cartridge-attachment section 110 is pivotally moved upward into the attached posture to be engaged with the locking portion 145, so that the locking portion 145 can hold the ink cartridge 30 in the attached posture (the attached position) in the cartridge-attachment section 110 against a rearward urging force generated by a coil spring 78 in the ink cartridge 30.

<Contacts 106>

As illustrated in FIGS. 2 and 7, four sets of three contacts 106 are disposed on the top wall of the case 101 at positions near the end wall of the case 101. As illustrated in FIG. 2, the three contacts 106 in each set are arranged to be spaced apart from one another in the left-right direction 55 and 56. This arrangement of the three contacts 106 in each set corresponds to an arrangement of an electrode group 65 of the ink cartridge 30 which will be described later (see FIGS. 3A and 4A). Each of the contacts 106 is formed of material having electrical conductivity and resiliency. The contacts 106 are therefore upwardly resiliently deformable. Note that the number of contacts 106 and electrodes provided corresponding thereto in the electrode group 65 are arbitrary.

Each of the contacts 106 is electrically connected to an arithmetic-logic unit via electrical circuits. The arithmetic-logic unit includes a CPU, a ROM, and a RAM, for example. The arithmetic-logic unit may be configured as a controller of the printer 10. When the contacts 106 are electrically connected to the electrode group 65 of the corresponding ink cartridge 30, a voltage Vc is applied to one electrode in the electrode group 65; another electrode in the electrode group 65 is grounded; and a power is supplied to another electrode in the electrode group 65. Due to the establishment of the electrical connection between the contacts 106 and the corresponding electrodes in the electrode group 65, data stored in an IC of the ink cartridge 30 is made electrically accessible. Outputs from the electrical circuits are inputted into the arithmetic-logic unit.

<Rods 125>

As illustrated in FIGS. 2 and 7, each of the rods 125 protrudes rearward from the end wall of the case 101. Specifically, each of the rods 125 is provided at the end wall of the case 101 at a position upward relative to a corresponding one of the ink needles 102. Each of the rods 125 is shaped like an upper half portion of a cylinder. That is, the rod 125 has an inverted U-shape in cross-section taken along a plane perpendicular to the front-rear direction 51 and 52. The rod 125 has a rib that protrudes upward from an uppermost portion of the inverted U-shape. The rib extends in the front-rear direction 51 and 52. In a state where the ink cartridge 30 is attached to the cartridge-attachment section 110, i.e., in a state where the ink cartridge 30 is in its attached position, the rod 125 is inserted into a recessed portion 96 (described later) of the ink cartridge 30 provided at a position downward of an IC board 64 (described later).

<Optical Sensors 103>

As illustrated in FIGS. 2 and 7, four of the optical sensors 103 are disposed at the top wall of the case 101. Each of the optical sensors 103 includes a light-emitting element and a light-receiving element. The light-emitting element is configured to emit light in the left-right direction 55 and 56, and the light-receiving element is configured to receive the light emitted from the light-emitting element. The light-emitting element and the light-receiving element are arranged to oppose and to be spaced apart from each other in the left-right direction 55 and 56. When the ink cartridge 30 has been completely attached to the cartridge-attachment section 110, a light-blocking plate 62 (described later) of the ink cartridge 30 is positioned between the light-emitting element and the light-receiving element of the corresponding optical sensor 103 in the left-right direction 55 and 56. In other words, the light-emitting element and the light-receiving element of the optical sensor 103 are arranged to oppose each other with the light-blocking plate 62 of the attached ink cartridge 30 interposed therebetween.

The optical sensor 103 is configured to output different detection signals depending on whether light emitted from the light-emitting element is received by the light-receiving element. For example, the optical sensor 103 outputs a low-level signal (a signal whose level is less than a threshold level) when the light emitted from the light-emitting element is not received by the light-receiving element (i.e., when an intensity of the light received at the light-receiving element is less than a predetermined intensity). On the other hand, the optical sensor 103 outputs a high-level signal (a signal whose level is equal to or greater than the threshold level) when the light emitted from the light-emitting element is received by the light-receiving element (i.e., when the intensity of the light received at the light-receiving element is equal to or greater than the predetermined intensity).

<Optical Sensors 113>

As illustrated in FIG. 7, four of the optical sensors 113 are also disposed at the top wall of the case 101. Each of the optical sensors 113 is provided at a position frontward of the corresponding optical sensor 103 and rearward of the corresponding set of contacts 106. Each of the optical sensors 113 includes a light-emitting element and a light-receiving element. The light-emitting element is configured to emit light in the left-right direction 55 and 56, and the light-receiving element is configured to receive the light emitted from the light-emitting element. The light-emitting element and the light-receiving element are arranged to oppose and to be spaced apart from each other in the left-right direction 55 and 56. When the ink cartridge 30 has been attached to the cartridge-attachment section 110, a light-blocking plate 67 (described later) of the ink cartridge 30 is positioned between the light-emitting element and the light-receiving element of the corresponding optical sensor 113 in the left-right direction 55 and 56. In other words, the light-emitting element and the light-receiving element of the optical sensor 113 are arranged to oppose each other with the light-blocking plate 67 of the attached ink cartridge 30 interposed therebetween.

The optical sensor 113 is configured to output different detection signals depending on whether light emitted from the light-emitting element in the left-right direction 55 and 56 is received by the light-receiving element. For example, the optical sensor 113 outputs a low-level signal when the light emitted from the light-emitting element is not received by the light-receiving element (i.e., when an intensity of the light received at the light-receiving element is less than a predetermined intensity). On the other hand, the optical sensor 113 outputs a high-level signal when the light emitted from the light-emitting element is received by the light-receiving element (i.e., when the intensity of the light received at the light-receiving element is equal to or greater than the predetermined intensity).

<Ink Cartridges 30>

The ink cartridge 30 illustrated in FIGS. 3A to 6 is a container configured to store ink therein. The ink cartridge 30 defines an inner space therein serving as the ink chamber 36 configured to store ink. In the present embodiment, the ink chamber 36 is formed by an inner frame 35 which is accommodated in a rear cover 31 and a front cover 32 those constituting an outer shell of the ink cartridge 30. Alternatively, the ink chamber 36 may be formed by the rear cover 31 and the front cover 32, for example.

The posture of the ink cartridge 30 illustrated in FIGS. 3A to 6 and 11 is a posture when the ink cartridge 30 is in the attached state, i.e., the attached posture of the ink cartridge 30. As will be described later, the ink cartridge 30 includes a front wall 140, a rear wall 41, top walls 39 and 141, and bottom walls 42 and 142. In the posture of the ink cartridge 30 illustrated in FIGS. 3A to 6, a direction from the rear wall 41 toward the front wall 140 is coincident with the frontward direction 51; a direction from the front wall 140 toward the rear wall 41 is coincident with the rearward direction 52; a direction from the top walls 39 and 141 toward the bottom walls 42 and 142 is coincident with the downward direction 53; and a direction from the bottom walls 42 and 142 toward the top walls 39 and 141 is coincident with the upward direction 54.

When the ink cartridge 30 is attached to the cartridge-attachment section 110, the front wall 140 faces frontward; the rear wall 41 faces rearward; the bottom walls 42 and 142 face downward; and the top walls 39 and 141 face upward.

As illustrated in FIGS. 3A to 6, the ink cartridge 30 includes the rear cover 31, the front cover 32, and the inner frame 35 defining the ink chamber 36. The rear cover 31 has a substantially rectangular parallelepiped shape. The front cover 32 includes the front wall 140. The front cover 32 is assembled to the rear cover 31 to form the outer shell of the ink cartridge 30. The inner frame 35 is accommodated in the rear cover 31 and the front cover 32 assembled to each other.

In the attached posture, the ink cartridge 30 has a depth in the front-rear direction 51 and 52, a height in the up-down direction 53 and 54, and a width in the left-right direction 55 and 56. The ink cartridge 30 has a generally flat shape having the height in the up-down direction 53 and 54 and the depth in the front-rear direction 51 and 52 greater than the width in the left-right direction 55 and 56. A front surface of the front wall 140 is a surface of the front cover 32 facing frontward during the insertion of the ink cartridge 30 into the cartridge-attachment section 110. A rear surface of the rear wall 41 is a surface of the rear cover 31 facing backward during the insertion of the ink cartridge 30 into the cartridge-attachment section 110. That is, the rear wall 41 and the front wall 140 are disposed to oppose each other with the ink chamber 36 interposed therebetween.

<Rear Cover 31>

As illustrated in FIGS. 3A to 4B, the rear cover 31 includes the rear wall 41, side walls 37 and 38, the top wall 39, and the bottom wall 42. The side walls 37 and 38 are spaced apart from each other in the left-right direction 55 and 56. The top wall 39 constitutes an upper end of the rear cover 31 and faces upward. The bottom wall 42 constitutes a lower end of the rear cover 31 and faces downward. The side walls 37 and 38, the top wall 39, and the bottom wall 42 extend frontward from the rear wall 41. That is, the rear cover 31 has a box-like shape formed with an opening that is open frontward. The inner frame 35 is inserted into the rear cover 31 via this opening. In other words, the rear cover 31 covers a rear portion of the inner frame 35. In a state where the inner frame 35 is inserted in the rear cover 31, the ink chamber 36 is arranged to be interposed between the top wall 39 and the bottom wall 42.

As illustrated in FIG. 5, the rear cover 31 is positioned rearward of the front cover 32 in the attached posture of the ink cartridge 30. A length L1 in the front-rear direction 51 and 52 from a rear edge of the rear cover 31 to a boundary between the rear cover 31 and the front cover 32 is greater than a length L2 in the front-rear direction 51 and 52 between a front edge of the front cover 32 to the boundary between the rear cover 31 and the front cover 32. In the present embodiment, a portion from the rear edge of the rear cover 31 to the boundary between the rear cover 31 and the front cover 32 are positioned rearward relative to the light-blocking plate 67 and the IC board 64 of the front cover 32.

Note that the length L1 and the length L2 may be equal to each other. That is, any dimensional relationship may be employed as long as the length L1 is greater than or equal to the length L2. Note that the length L1 is defined as the maximum length in the front-rear direction 51 and 52 from the boundary between the rear cover 31 and the front cover 32 to the rear edge of the rear cover 31, while the length L2 is defined as the maximum length in the front-rear direction 51 and 52 from the boundary to the front edge of the front cover 32 for the purpose of comparison.

In the present embodiment, the rear cover 31 and the front cover 32 are assembled to each other such that a rear edge of the front cover 32 is overlapped with a front edge (an outer surface thereof) of the rear cover 31 to form the boundary between the rear cover 31 and the front cover 32 on each side surface of the ink cartridge 30. Alternatively, the front edge of the rear cover 31 may be overlapped with the rear edge (an outer surface thereof) of the front cover 32 to form the boundary between the rear cover 31 and the front cover 32 on each side surface of the ink cartridge 30. Still alternatively, the rear edge of the front cover 32 and the front edge of the rear cover 31 may face each other in the front-rear direction 51 and 52 to form the boundary between the rear cover 31 and the front cover 32.

The rear wall 41 includes an upper portion 41U and a lower portion 41L, as illustrated in FIGS. 3A to 4B. The upper portion 41U is arranged above the lower portion 41L. The lower portion 41L is positioned frontward relative to the upper portion 41U. The upper portion 41U and the lower portion 41L are both planar shaped, and intersect each other but are not perpendicular to each other. Specifically, the lower portion 41L is inclined relative to the up-down direction 53 and 54 such that the lower portion 41L extends closer to the front wall 140 toward the bottom wall 42.

As illustrated in FIG. 5, the bottom wall 42 is inclined relative to the front-rear direction 51 and 52 such that a front end of the bottom wall 42 is positioned lower than a rear end of the bottom wall 42. Note that, a phantom line PL parallel to the front-rear direction 51 and 52 is indicated in FIG. 5 in order to clarify the slope of the bottom wall 42 relative to the front-rear direction 51 and 52. The front end of the bottom wall 42 (the inclined surface) constitutes the front edge of the rear cover 31. The front end of the bottom wall 42 (the inclined surface) is positioned frontward of a locking surface 151 (described later) of the ink cartridge 30. The rear end of the bottom wall 42 (the inclined surface) is connected to a lower end of the lower portion 41L of the rear wall 41.

As illustrated in FIGS. 3A and 4A, a protrusion 43 is provided on a top surface of the top wall 39 of the rear cover 31. The protrusion 43 is arranged on a center of the top wall 39 in the left-right direction 55 and 56 to extend in the front-rear direction 51 and 52. The protrusion 43 has a rear surface facing rearward and extending in the up-down direction 53 and 54. This rear surface of the protrusion 43 functions as the locking surface 151 of the ink cartridge 30. The locking surface 151 is positioned above the bottom wall 42 of the rear cover 31.

The locking surface 151 is configured to face the locking portion 145 in the rearward direction 52 and abut on the locking portion 145 in the attached state of the ink cartridge 30 to the cartridge-attachment section 110. The abutment of the locking surface 151 on the locking portion 145 enables the ink cartridge 30 to be held in the attached state in the cartridge-attachment section 110 against a rearward urging force applied from the coil spring 78.

The protrusion 43 also has a horizontal surface 154, and a sloped surface 155. The horizontal surface 154 is connected to an upper edge of the locking surface 151 to extend frontward therefrom. The horizontal surface 154 is thus positioned frontward of the locking surface 151. The horizontal surface 154 is a surface extending both in the front-rear direction 51 and 52 and in the left-right direction 55 and 56. The sloped surface 155 is connected to a front edge of the horizontal surface 154 to extend frontward therefrom. The sloped surface 155 is thus positioned frontward of the horizontal surface 154. The sloped surface 155 faces frontward and upward. In this way, the sloped surface 155 and the locking surface 151 are connected to each other via the horizontal surface 154, so that a boundary edge between the locking surface 151 and the sloped surface 155 does not constitute a ridge-like shape.

During the insertion of the ink cartridge 30 into the cartridge-attachment section 110, the locking portion 145 is smoothly guided toward the rear beyond the locking surface 151 while making contact with and sliding along the sloped surface 155 and the horizontal surface 154.

An operation portion 90 is also provided on the top surface of the top wall 39 of the rear cover 31. The operation portion 90 is positioned further rearward relative to the locking surface 151. The top surface of the top wall 39 has a rear end portion that is arranged downward relative to a remaining portion of the top surface of the top wall 39. The rear end portion of the top surface of the top wall 39 serves as a sub-top surface 91. That is, the sub-top surface 91 is positioned lower than the remaining portion on the top surface of the top wall 39.

The operation portion 90 is disposed upward relative to the sub-top surface 91 and is spaced apart therefrom. The operation portion 90 has a generally flat plate-like shape. Specifically, the operation portion 90 protrudes upward from a region near the boundary between the sub-top surface 91 and the remaining portion on the top surface of the top wall 39, extends further upward than the protrusion 43, and is then bent obliquely rearward and downward.

A rib 94 is provided between the sub-top surface 91 and the operation portion 90. The rib 94 is connected to both the operation portion 90 and the sub-top surface 91, and extends in the front-rear direction 51 and 52. As illustrated in FIG. 11, with respect to the left-right direction 55 and 56, the rib 94 has a dimension that is smaller than each of a dimension of the sub-top surface 91 and a dimension of the operation portion 90.

The operation portion 90 has a surface facing upward and rearward. This surface serves as an operation surface 92. The operation surface 92 and the sub-top surface 91 are aligned with each other at least partially in the up-down direction 53 and 54. In other words, when the ink cartridge 30 is viewed from above, the operation surface 92 and the sub-top surface 91 are overlapped with each other. On the operation surface 92, a plurality of ridges 93 is formed as a plurality of projections. The ridges 93 extend in the left-right direction 55 and 56 and are spaced apart from one another in the front-rear direction 51 and 52. These ridges 93 allow the user to easily recognize the operation surface 92. The ridges 93 can also serve to prevent a user's finger from slipping over the operation surface 92 when the user operates the operation surface 92.

The operation surface 92 is visible when the ink cartridge 30 is viewed from above and rearward thereof. The user operates the operation surface 92 in an attempt to remove the ink cartridge 30 attached to the cartridge-attachment section 110 therefrom. The operation portion 90 is fixed to the rear cover 31 so as not to move relative to the rear cover 31. For example, the operation portion 90 may be formed integrally with the rear cover 31 so as not to be pivotally moved relative thereto. Thus, a force applied from the user to the operation surface 92 is directly transmitted to the rear cover 31 without changing a direction of the force. In the present embodiment, the operation portion 90 is further configured not to make any movement relative to the inner frame 35 and the ink chamber 36. That is, the operation portion 90 is not pivotally movable relative to the inner frame 35 nor to the ink chamber 36.

The light-blocking plate 62 is provided on the top surface of the top wall 39 of the rear cover 31 to protrude upward therefrom. The light-blocking plate 62 extends in the front-rear direction 51 and 52. The light-blocking plate 62 is positioned further frontward relative to the protrusion 43. Also, the light-blocking plate 62 is positioned further rearward relative to the electrode group 65 (described later) and extends further upward than the electrode group 65. The light-blocking plate 62 has a left surface 62L and a right surface 62R, and one of the left surface 62L and the right surface 62R serves as an attenuating surface configured to attenuate incident light.

The light-blocking plate 62 is made of resin and formed (molded) integrally with the top wall 39. That is, the light-blocking plate 62 and the top wall 39 are configured as a single member. In addition, a rear end of the light-blocking plate 62 and the outer shell of the ink cartridge 30 (e.g., the rear cover 31) are formed as a single member (i.e., are integrally molded) in the present embodiment. Specifically, both the rear end and a lower end of the light-blocking plate 62, and the outer shell of the ink cartridge 30 are formed as a single member in the present embodiment to thereby realize a configuration in which the light-blocking plate 62 is immovable relative to the outer shell of the ink cartridge 30 as will be described later in detail. However, the configuration of the light-blocking plate 62 need not be limited to that in the present embodiment, and other configurations may be employed as long as the light-blocking plate 62 is immovable relative to the outer shell of the ink cartridge 30. That is, one of the rear end and the lower end of the light-blocking plate 62 just needs to be integrally formed with the outer shell of the ink cartridge 30. For example, a configuration can be employed in which the lower end of the light-blocking plate 62 is integrally formed with the outer shell of the ink cartridge 30 but the rear end of the light-blocking plate 62 is not, and vice versa.

The light-blocking plate 62 does not contact ink stored in the ink chamber 36 defined by the inner frame 35. The light-blocking plate 62 has an upper end 62H positioned further downward relative to the locking surface 151 of the protrusion 43. In other words, the locking surface 151 extends further upward than the light-blocking plate 62.

The light-blocking plate 62 is configured to block the light emitted from the optical sensor 103 and traveling in the left-right direction 55 and 56. More specifically, when the light emitted from the light-emitting element of the optical sensor 103 is incident on the light-blocking plate 62 (i.e., on one of the left surface 62L and the right surface 62R) before arriving at the light-receiving element, the intensity of the light received at the light-receiving element is less than a predetermined intensity, for example, zero. Note that the light-blocking plate 62 may completely block the light traveling in the left-right direction 55 and 56, or may partially attenuate the light, or may totally reflect the light.

<Front Cover 32>

As illustrated in FIGS. 3A to 4B, the front cover 32 includes the front wall 140, side walls 143 and 144, the top wall 141, and the bottom wall 142. The side walls 143 and 144 are spaced apart from each other in the left-right direction 55 and 56. The top wall 141 and the bottom wall 142 are spaced apart from each other in the up-down direction 53 and 54. The side walls 143 and 144, the top wall 141, and the bottom wall 142 extend rearward from the front wall 140. That is, the front cover 32 has a box-like shape formed with an opening that is open rearward. The inner frame 35 is inserted into the front cover 32 via this opening. That is, the front cover 32 covers a front portion of the inner frame 35 that is not covered by the rear cover 31.

In a state where the front cover 32 and the rear cover 31 are assembled to each other, that is, in a state where assembly of the ink cartridge 30 is completed, the top wall 141 of the front cover 32 and the top wall 39 of the rear cover 31 constitute a top wall of the ink cartridge 30; the bottom wall 142 of the front cover 32 and the bottom wall 42 of the rear cover 31 constitute a bottom wall of the ink cartridge 30; and the side walls 143 and 144 of the front cover 32 and the side walls 37 and 38 of the rear cover 31 respectively constitute the side walls of the ink cartridge 30.

Hence, in the assembled ink cartridge 30, a top surface of the top wall 141 and the top surface of the top wall 39 constitute a top surface of the ink cartridge 30; a bottom surface of the bottom wall 142 and a bottom surface of the bottom wall 42 constitute a bottom surface of the ink cartridge 30; and outer surfaces of the side walls 143 and 144 and outer surfaces of the side walls 37 and 38 constitute respective side surfaces of the ink cartridge 30.

In the attached posture of the ink cartridge 30, the bottom wall 142 of the front cover 32 extends in the front-rear direction 51 and 52, and the bottom wall 42 of the rear cover 31 is sloped to face downward and rearward.

Further, in the state where the ink cartridge 30 is assembled, the front wall 140 of the front cover 32 constitutes a front wall of the ink cartridge 30, whereas the rear wall 41 of the rear cover 31 constitutes a rear wall of the ink cartridge 30. The front wall of the ink cartridge 30 (the front wall 140 of the front cover 32) and the rear wall of the ink cartridge 30 (the rear wall 41 of the rear cover 31) are arranged to be spaced apart from each other in the front-rear direction 51 and 52. That is, in the attached posture, a front surface of the front wall 140 constitutes a front surface of the ink cartridge 30; and a rear surface of the rear wall 41 constitutes a rear surface of the ink cartridge 30.

Incidentally, the front surface, the rear surface, the top surface, the bottom surface, and the side surfaces constituting the ink cartridge 30 need not be configured as one flat plane, respectively. That is, the front surface of the ink cartridge 30 can be any surface(s) that can be seen when the ink cartridge 30 in its attached posture is viewed from its front side, and that is(are) positioned frontward relative to a center in the front-rear direction 51 and 52 of the ink cartridge 30. The rear surface of the ink cartridge 30 can be any surface(s) that can be seen when the ink cartridge 30 in its attached posture is viewed from its rear side, and that is(are) positioned rearward relative to the center in the front-rear direction 51 and 52 of the ink cartridge 30.

The top surface of the ink cartridge 30 can be any surface(s) that can be seen when the ink cartridge 30 in its attached posture is viewed from above, and that is(are) positioned upward relative to a center in the up-down direction 53 and 54 of the ink cartridge 30. The bottom surface of the ink cartridge 30 can be any surface(s) that can be seen when the ink cartridge 30 in its attached posture is viewed from below, and that is(are) positioned downward relative to the center in the up-down direction 53 and 54 of the ink cartridge 30. The same is applied to the side surfaces of the ink cartridge 30.

In addition, the front side (e.g., the front wall) of the ink cartridge 30 (the front wall 140 of the front cover 32 or a front wall 40 of the inner frame 35) and the rear side (e.g., the rear wall) of the ink cartridge 30 (the rear wall 41 of the rear cover 31) are provided opposite each other in the front-rear direction 51 and 52. Also, the front side of the ink cartridge 30 is an area positioned frontward relative to the center in the front-rear direction 51 and 52 of the ink cartridge 30, while the rear side of the ink cartridge 30 is an area positioned rearward relative to the center in the front-rear direction 51 and 52 of the ink cartridge 30.

The upper side (e.g., the top wall) of the ink cartridge 30 (the top walls 39 and 141) and the lower side (e.g., the bottom wall) of the ink cartridge 30 (the bottom walls 42 and 142) are provided opposite each other in the up-down direction 53 and 54. The upper side of the ink cartridge 30 is an area positioned upward relative to the center in the up-down direction 53 and 54 of the ink cartridge 30, while the lower side of the ink cartridge 30 is an area positioned downward relative to the center in the up-down direction 53 and 54 of the ink cartridge 30. The same is applied with respect to the left side and the right side of the ink cartridge 30.

The recessed portion 96 is formed in an upper portion of the front wall 140 of the front cover 32 to be recessed rearward. The recessed portion 96 is configured to receive the corresponding rod 125 therein when the ink cartridge 30 has been attached to the cartridge-attachment section 110. Accordingly, the recessed portion 96 has a cross-section taken along a plate perpendicular to the front-rear direction 51 and 52 corresponding to that of the rod 125.

A through-hole 97 is formed in a lower portion of the front wall 140 to penetrate the same in the front-rear direction 51 and 52. When the inner frame 35 is inserted in the front cover 32, the ink supply portion 34 provided at the inner frame 35 is exposed outside through the through-hole 97. Accordingly, the through-hole 97 is formed at a position, with a size and a shape corresponding to those of the ink supply portion 34 of the inner frame 35.

A first protruding portion 85 and a second protruding portion 86 are formed on the front surface of the front wall 140. The first protruding portion 85 protrudes frontward from an upper end portion of the front cover 32. The first protruding portion 85 has a front end constituting a part of the front surface of the front wall 140. The recessed portion 96 is formed on the front end of the first protruding portion 85.

The second protruding portion 86 protrudes frontward from a lower end portion of the front cover 32. That is, the second protruding portion 86 is positioned further downward relative to the ink supply portion 34. On a lower portion of the second protruding portion 86, a recess 87 is formed to open downward and frontward. A portion of the recess 87 protrudes further downward than the bottom surface of the bottom wall 142 of the front cover 32.

The light-blocking plate 67 is provided at the top surface of the top wall 141 of the front cover 32 to protrude upward therefrom. The light-blocking plate 67 extends in the front-rear direction 51 and 52. In the assembled ink cartridge 30, the light-blocking plate 67 is positioned further frontward relative to the light-blocking plate 62 of the rear cover 31. In this state, the light-blocking plate 67 and the light-blocking plate 62 define a space 61 therebetween in the front-rear direction 51 and 52. The space 61 allows the light emitted from the optical sensor 103 to transmit therethrough. The light-blocking plate 67 is positioned further rearward relative to the electrode group 65 (described later).

The light-blocking plate 67 is configured to block the light emitted from the optical sensor 113 and traveling in the left-right direction 55 and 56. More specifically, when the light emitted from the light-emitting element of the optical sensor 113 is incident on the light-blocking plate 67 before arriving at the light-receiving element, the intensity of the light received at the light-receiving element is less than a predetermined intensity, for example, zero. Note that the light-blocking plate 67 may completely block the light traveling in the left-right direction 55 and 56, may partially attenuate the light, or may totally reflect the light.

Further, the light-blocking plate 67 is configured to block the light emitted from the optical sensor 103 and traveling in the left-right direction 55 and 56 in the middle of the insertion of the ink cartridge 30 into the cartridge-attachment section 110.

The IC board 64 is provided on the top surface of the top wall 141. The IC board 64 is arranged further upward relative to the first protruding portion 85, i.e., further upward relative to the ink supply portion 34. The IC board 64 is electrically connected to the corresponding three contacts 106 arranged in the left-right direction 55 and 56 during the insertion of the ink cartridge 30 into the cartridge-attachment section 110, as well as upon completion of the attachment of the ink cartridge 30 to the cartridge-attachment section 110.

As illustrate in FIGS. 3A, 4A, and 11, an IC (not illustrated) and first to third electrodes 65A to 65C are mounted on the IC board 64. The first to third electrodes 65A to 65C are hereinafter collectively referred to as the electrode group 65 where appropriate. The electrode group 65 is arranged in the left-right direction 55 and 56. The IC is a semiconductor integrated circuit and readably stores therein data indicating information on the ink cartridge 30, such as a lot number, a production date, and a color of the ink.

Each electrode in the electrode group 65 is electrically connected to the IC. The electrodes of the electrode group 65 extend in the front-rear direction 51 and 52 and arranged to be spaced apart from one another in the left-right direction 55 and 56. Among the three electrodes 65A, 65B, and 65C, the first electrodes 65A constitutes a left end of the electrode group 65 in the left-right direction 55 and 56, while the second electrode 65B constitutes a right end of the electrode group 65 in the left-right direction 55 and 56. The third electrode 65C is positioned between the first electrode 65A and the second electrode 65B in the left-right direction 55 and 56. The electrode group 65 is formed on an upper surface of the IC board 64 to face upward so that the electrode group 65 is electrically accessible from the outside. Note that the number of electrodes in the electrode group 65 is arbitrary as long as the electrode group 65 includes at least three electrodes.

<Inner Frame 35>

Although not illustrated in the drawings, the inner frame 35 has a generally annular shape, with a pair of side surfaces in the left-right direction 55 and 56 opened. The respective open side surfaces of the inner frame 35 are sealed with films (not illustrated) to form the ink chamber 36 for storing ink therein. The inner frame 35 includes the front wall 40 that faces the front wall 140 of the front cover 32 when the inner frame 35 is inserted in the front cover 32. More specifically, a front surface of the front wall 40 faces a rear surface (opposite the front surface) of the front wall 140 when the inner frame 35 is inserted in the front cover 32. The ink supply portion 34 is disposed at the front surface of the front wall 40.

The rear cover 31 is fixed to the inner frame 35. The front cover 32 is movable in the front-rear direction 51 and 52 and in the up-down direction 53 and 54 relative to the inner frame 35.

Specifically, as illustrated in FIGS. 3A to 5, openings 115 are formed in the respective side walls 143 and 144 of the front cover 32. The inner frame 35 includes protrusions 116 each at a position corresponding to one of the openings 115 as illustrated in FIG. 5. The protrusions 116 protrude outward in the left-right direction 55 and 56 so that the protrusions 116 are received in the respective openings 115. Each of the openings 115 has dimensions in the front-rear direction 51 and 52 and in the up-down direction 53 and 54 greater than dimensions of the corresponding protrusion 116 in the front-rear direction 51 and 52 and in the up-down direction 53 and 54, respectively.

Since the protrusions 116 are moved inside the corresponding openings 115 in the front-rear direction 51 and 52, the front cover 32 is movable in the front-rear direction 51 and 52 relative to the inner frame 35. Further, the front cover 32 is movable in the up-down direction 53 and 54 relative to the inner frame 35, since the protrusions 116 are moved inside the corresponding openings 115 in the up-down direction 53 and 54.

<Ink Supply Portion 34>

As illustrated in FIG. 6, the ink supply portion 34 protrudes frontward from the front wall 40 of the inner frame 35. The ink supply portion 34 has a cylindrical outer shape. The ink supply portion 34 protrudes outward (frontward) through the through-hole 97 formed in the front wall 140 of the front cover 32 in the state where the inner frame 35 is accommodated in the front cover 32. That is, the ink supply portion 34 is positioned at the lower portion of the front wall 140. The ink supply portion 34 includes the cylindrical-shaped tubular wall 73 defining the internal space therein, a sealing member 76, and a cap 79. The sealing member 76 and the cap 79 are attached to the tubular wall 73.

The tubular wall 73 extends to connect the interior and exterior of the ink chamber 36. The tubular wall 73 has a rear end that is open in the ink chamber 36, and a front end that is open to the outside of the ink cartridge 30. Accordingly, the tubular wall 73 provides fluid communication between the ink chamber 36 and the outside of the ink cartridge 30 through the internal space of the tubular wall 73. The ink supply portion 34 can thus supply the ink stored in the ink chamber 36 to the outside of the ink cartridge 30 via the internal space of the tubular wall 73. The sealing member 76 and the cap 79 are attached to the front end of the tubular wall 73.

In the internal space of the tubular wall 73, a valve 77 and the coil spring 78 are accommodated. The valve 77 and the coil spring 78 serve to switch a state of the ink supply portion 34 between a state illustrated in FIG. 10 and a state illustrated in FIG. 6. That is, in the state illustrated in FIG. 10, the ink is allowed to flow out of the ink chamber 36 to the outside of the ink cartridge 30 via the internal space of the tubular wall 73. In the state illustrated in FIG. 6, the ink is not allowed to flow out of the internal space of the tubular wall 73 to the outside of the ink cartridge 30.

The valve 77 is movable in the front-rear direction 51 and 52 to open and close the ink supply port 71 formed at a center of the sealing member 76. The coil spring 78 urges the valve 77 frontward. Accordingly, without application of an external force, the valve 77 closes off the ink supply port 71 of the sealing member 76.

As described above, the sealing member 76 is provided at the front end of the tubular wall 73. The sealing member 76 is formed of elastic material such as rubber or elastomer. The sealing member 76 is disc-like shaped and has a center portion in which a through-hole is formed. The through-hole penetrates the center portion of the sealing member 76 in the front-rear direction 51 and 52 to provide a tubular-shaped inner circumferential surface that defines the ink supply port 71. The ink supply port 71 has an inner diameter that is slightly smaller than an outer diameter of the ink needle 102. The cap 79 is externally fitted to the tubular wall 73, with the sealing member 76 attached to the front end of the tubular wall 73, so that the sealing member 76 is in liquid-tight contact with the front end of the tubular wall 73.

As the ink cartridge 30 is inserted into the cartridge-attachment section 110 in a state where the valve 77 closes the ink supply port 71, the ink needle 102 enters the ink supply port 71. An outer circumferential surface of the ink needle 102 is brought into contact with the inner circumferential surface of the sealing member 76 that defines the ink supply port 71 to provide a liquid-tight seal therewith, while elastically deforming the sealing member 76. When a tip end portion of the ink needle 102 is moved past the sealing member 76 and enters the internal space of the tubular wall 73, the ink needle 102 comes in contact with the valve 77. As the ink cartridge 30 is further inserted into the cartridge-attachment section 110, the ink needle 102 moves the valve 77 rearward against the urging force of the coil spring 78. Accordingly, the ink stored in the ink chamber 36 can flow into the tip end portion of the ink needle 102 via the internal space of the tubular wall 73.

Although not illustrated in the drawings, through-holes are formed in the tip end portion of the ink needle 102. Through these through-holes of the ink needle 102, the ink is allowed to flow from the internal space of the tubular wall 73 into an internal space of the ink needle 102. In this way, the ink stored in the ink chamber 36 can flow outside the ink cartridge 30 through the internal spaces of the tubular wall 73 and the ink needle 102.

Incidentally, the ink supply portion 34 may not be provided with the valve 77 for closing the ink supply port 71. Instead, for example, the ink supply port 71 may be closed with a film. In this case, the ink needle 102 may break through the film at the time of insertion of the ink cartridge 30 into the cartridge-attachment section 110, thereby allowing the tip end portion of the ink needle 102 to enter the internal space of the tubular wall 73 through the ink supply port 71. Still alternatively, the ink supply port 71 may be closed with an elastic force of the sealing member 76 itself In this case, the ink supply port 71 may be pushed and enlarged by the ink needle 102 only when the ink needle 102 is inserted in the ink supply port 71.

<Arrangement of Light-Blocking Plate 62>

Although both the left surface 62L and the right surface 62R of the light-blocking plate 62 can serve as an attenuating surface that attenuates the incident light as described above, the arrangement of the light-blocking plate 62 in a case where the right surface 62R is an attenuating surface will be described below. As indicated by a broken line in FIG. 5, the right surface 62R has a detection area 63. In a state where the ink cartridge 30 is in the attached state, the light emitted from the optical sensor 103 is incident on the detection area 63 of the right surface 62R.

The detection area 63 is positioned further rearward and upward relative to the electrode group 65, and is positioned further frontward and downward relative to the locking surface 151. Further, the detection area 63 does not move to a position where the light-blocking plate 62 is not detected by the optical sensor 103 (i.e., where the light emitted from the optical sensor 103 is not incident on the detection area 63). Note that “the detection area 63 does not move” denotes that the detection area 63 does not move relative to the rear cover 31 in the attached state of the ink cartridge 30. That is, the light-blocking plate 62 (i.e., the detection area 63) is immovable both in the front-rear direction 51 and 52 and in the up-down direction 53 and 54 relative to the locking surface 151. The light-blocking plate 62 (i.e., the detection area 63) is also immovable both in the front-rear direction 51 and 52 and in the up-down direction 53 and 54 relative to the electrode group 65. That is, the light-blocking plate 62 (i.e., the detection area 63) is immovable relative to the outer shell of the ink cartridge 30 constituted by the front cover 32 and the rear cover 31.

As illustrated in FIG. 5, when viewed in the leftward direction 56, the detection area 63 is positioned within an area defined by a first imaginary line S1, a second imaginary line S1, and a third imaginary line S3. The first imaginary line S1 passes through both a center in the front-rear direction 51 and 52 of the electrode group 65 and a center in the up-down direction 53 and 54 of the locking surface 151. The second imaginary line S2 passes through both a center of the ink supply port 71 of the ink supply portion 34 and the center in the front-rear direction 51 and 52 of the electrode group 65. The third imaginary line S3 passes through both the center of the ink supply port 71 and the center in the up-down direction 53 and 54 of the locking surface 151.

As illustrated in FIG. 11, both ends in the left-right direction 55 and 56 of the light-blocking plate 62, i.e., the left surface 62L and the right surface 62R of the light-blocking plate 62 are positioned further inward than both ends in the left-right direction 55 and 56 of the electrode group 65, i.e., the left end of the first electrode 65A and the right end of the second electrode 65B, respectively. Also, both the upper end 62H of the light-blocking plate 62 and the first electrode 65A are arranged to intersect an imaginary plane F extending both in the front-rear direction 51 and 52 and in the up-down direction 53 and 54.

<Attachment/Detachment of Ink Cartridge 30 Relative to/from Cartridge-Attachment Section 110>

Next, a process for attaching the ink cartridge 30 to the cartridge-attachment section 110 will be described.

As illustrated in FIG. 7, in the ink cartridge 30 before insertion thereof into the cartridge-attachment section 110, the valve 77 closes off the ink supply port 71 of the sealing member 76. Accordingly, at this time, ink flow from the ink chamber 36 to the outside of the ink cartridge 30 is interrupted.

Further, in a state prior to attachment of the ink cartridge 30 to the cartridge-attachment section 110 illustrated in FIG. 7, nothing is positioned between the light-emitting element and the light-receiving element of the optical sensor 103. The optical sensor 103 therefore outputs a high-level signal to the controller (i.e., the arithmetic-logic unit) of the printer 10. Similarly, since nothing is positioned between the light-emitting element and the light-receiving element of the optical sensor 113, the optical sensor 113 also outputs a high-level signal to the controller of the printer 10.

For attaching the ink cartridge 30 to the cartridge-attachment section 110, the ink cartridge 30 is inserted frontward into the case 101 of the cartridge-attachment section 110 through the opening 112, as illustrated in FIG. 7. Since the upper portion 41U of the rear wall 41 of the rear cover 31 is positioned rearward relative to the lower portion 41L of the rear wall 41, that is, since the upper portion 41U is positioned closer to the user than the lower portion 41L is to the user, the user can push the upper portion 41U to insert the ink cartridge 30 frontward into the cartridge-attachment section 110.

At the time of insertion of the ink cartridge 30 into the case 101 of the cartridge-attachment section 110, a lower portion of the ink cartridge 30, that is, lower portions of the front cover 32 and the rear cover 31, are inserted into the corresponding lower guide groove 109 formed in the bottom wall of the case 101. The second protruding portion 86 is provided at the lower portion of the front cover 32. As a portion of the recess 87 protruding downward from the bottom wall 142 of the front cover 32 abuts on the lower surface of the lower guide groove 109, a front portion of the front cover 32 is pressed upward such that the bottom wall 142 is inclined relative to the frontward direction 51. At this time, a portion of the recess 87 of the front cover 32 and a portion near a rear end of the bottom wall 142 abut on the lower surface of the lower guide groove 109.

As illustrated in FIG. 8, in accordance with the frontward movement of the ink cartridge 30 into the cartridge-attachment section 110, the cap 79 of the ink supply portion 34 starts entering the guide portion 105. Further, the recessed portion 96 of the front cover 32 opposes the rod 125, and the rod 125 starts entering the recessed portion 96.

Further, since the light-blocking plate 67 is positioned between the light-emitting element and the light-receiving element of the optical sensor 103 in the state illustrated in FIG. 8, the signal outputted from the optical sensor 103 changes from the high-level to the low-level. Note that the optical sensor 113 maintains outputting the high-level signal in this state.

As the ink cartridge 30 is inserted further frontward as illustrated in FIG. 9, the cap 79 of the ink supply portion 34 is inserted in the guide portion 105, and the ink needle 102 is moved past the ink supply port 71 to separate the valve 77 from the sealing member 76 against the urging force of the coil spring 78. The ink supply portion 34 is thus positioned relative to the cartridge-attachment section 110. The ink cartridge 30 is applied with the urging force of the coil spring 78 to be urged rearward.

Further, in the state illustrated in FIG. 9, a lower surface 85A of the first protruding portion 85 that faces downward is supported by a surface 170 constituting the case 101 of the cartridge-attachment section 110. The surface 170 faces upward and positioned further upward relative to the corresponding guide portion 105. Due to this contact between the lower surface 85A and the surface 170, the ink cartridge 30 is positioned in the up-down direction 53 and 54. Incidentally, the lower surface 85A is arranged to be overlapped with the IC board 64 when the ink cartridge 30 is viewed from above. Note that, a portion other than the surface 170, for example, the rod 125 may support the ink cartridge 30 to position the ink cartridge 30 in the up-down direction 53 and 54.

Further, in the state illustrated in FIG. 9, the rod 125 enters the recessed portion 96 to support the front cover 32 from below. As the IC board 64 reaches at a position below the contacts 106, the electrodes in the electrode group 65 are brought into electrical connection with the corresponding contacts 106 while elastically deforming the same upward. Although the IC board 64 is urged downward due to the elastic deformation of the contacts 106 in this state, positioning of the IC board 64 relative to the contacts 106 is performed accurately since the rod 125 supports the front cover 32 from below. Note that the rod 125 may not necessarily support the front cover 32 from below. For example, a cylindrical portion surrounding the ink needle 102 (i.e., the guide portion 105) may abut on the front cover 32 to support the same.

Further, in the state illustrated in FIG. 9, the light-blocking plate 67 and the space 61 pass through a portion between the light-emitting element and the light-receiving element of the optical sensor 103, and then, the light-blocking plate 62 is located between the light-emitting element and the light-receiving element of the optical sensor 103. Accordingly, the signal outputted from the optical sensor 103 changes from the low-level to the high-level, and changes again to and is maintained at the low-level. Since the light-blocking plate 67 is positioned between the light-emitting element and the light-receiving element of the optical sensor 113, the signal outputted from the optical sensor 113 changes from the high-level to the low-level. According to the fluctuations of the signals outputted from the optical sensors 103 and 113, the controller of the printer 10 can recognize that the ink cartridge 30 has been attached to the cartridge-attachment section 110.

Further, in the state illustrated in FIG. 9, the protrusion 43 of the rear cover 31 arrives at the locking portion 145 of the cartridge-attachment section 110. The sloped surface 155 of the protrusion 43 is moved frontward while making sliding contact with the locking portion 145, as the ink cartridge 30 is moved frontward. This contact between the sloped surface 155 and the locking portion 145 causes the ink cartridge 30 to be pivotally moved clockwise in FIG. 11 against a counterclockwise rotational moment that is applied to the ink cartridge 30 as a result of user's pushing of the upper portion 41U. Specifically, the ink cartridge 30 is pivotally moved clockwise in FIG. 11 about the center of the ink supply port 71 of the sealing member 76 in which the ink needle 102 is inserted, that is, about a center of a portion of the outer circumferential surface of the ink needle 102, the portion being in contact with the inner circumferential surface of the sealing member 76 defining the ink supply port 71.

Since the bottom wall 42 of the rear cover 31 is sloped relative to the front-rear direction 51 and 52, a space is available between the bottom wall 42 and the bottom wall of the cartridge-attachment section 110 as illustrated in FIG. 8. This space between the bottom wall 42 and the bottom wall of the cartridge-attachment section 110 enables the ink cartridge 30 to make the above-described pivotal movement (the clockwise pivotal movement in FIG. 9).

As the ink cartridge 30 is inserted further frontward against the urging force of the coil spring 78 as illustrated in FIG. 10, the sloped surface 155 and the horizontal surface 154 come to a location frontward of the locking portion 145, i.e., closer to the end wall of the case 101 than the locking portion 145 is to the end wall. Since the sloped surface 155 and the horizontal surface 154 are now separated from the locking portion 145, the ink cartridge 30 is pivoted counterclockwise (upward) in FIG. 10 about the center of the ink supply port 71 in which the ink needle 102 is inserted due to the counterclockwise rotational moment applied to the ink cartridge 30 by the user's frontward pushing of the upper portion 41U of the ink cartridge 30.

As a result, the locking surface 151 of the protrusion 43 faces the locking portion 145 rearward as illustrated in FIG. 10. When the user stops pushing the ink cartridge 30 frontward at this time, the ink cartridge 30 is moved rearward by the urging force of the coil spring 78. In response to the rearward movement of the ink cartridge 30, the locking surface 151 comes into contact with the locking portion 145 from the front side thereof. As a result of this contact of the locking surface 151 with the locking portion 145, the ink cartridge 30 is restricted from moving further rearward in the cartridge-attachment section 110. The ink cartridge 30 is thus fixed in position relative to the cartridge-attachment section 110 and is in the attached state, i.e., the attachment of the ink cartridge 30 relative to the cartridge-attachment section 110 is completed.

Next, a process for detaching the ink cartridge 30 from the cartridge-attachment section 110 will be described.

For detaching the ink cartridge 30 from the cartridge-attachment section 110, the user pushes the operation surface 92 of the ink cartridge 30 downward. In the attached posture of the ink cartridge 30 to the cartridge-attachment section 110 illustrated in FIG. 10, the operation surface 92 faces upward and rearward. Hence, when the user operates the operation surface 92 of the ink cartridge 30 positioned relative to the cartridge-attachment section 110 (in the attached state), the ink cartridge 30 is applied with a force acting downward and frontward. By the frontward force, the locking surface 151 is disengaged from the locking portion 145 of the cartridge-attachment section 110. By the downward force, the ink cartridge 30 is pivotally moved clockwise in FIG. 10.

By this clockwise pivotal movement of the ink cartridge 30 in FIG. 10, the locking surface 151 is moved downward to be positioned below the locking portion 145. The ink cartridge 30 is then caused to be moved rearward, relative to the cartridge-attachment section 110, due to the rearward urging force of the coil spring 78. Accordingly, the user can grasp the rear cover 31 of the ink cartridge 30 to pull the same rearward to remove the ink cartridge 30 from the cartridge-attachment section 110.

As the ink cartridge 30 is moved rearward, the light-blocking plate 67 is separated from the portion between the light-emitting element and the light-receiving element of the optical sensor 113. Accordingly, the signal outputted from the optical sensor 113 to the controller of the printer 10 changes from the low-level to the high-level. Further, the light-blocking plate 62 is separated from the portion between the light-emitting element and the light-receiving element of the optical sensor 103, and then the space 61 and the light-blocking plate 67 pass through the portion between the light-emitting element and the light-receiving element of the optical sensor 103. Therefore, the signal outputted from the optical sensor 103 to the controller of the printer 10 changes from the low-level to the high-level, changes to the low-level, and then changes to the high-level. With these fluctuations of the signals outputted from the optical sensors 103 and 113, the controller of the printer 10 can recognize that the ink cartridge 30 has been extracted from the cartridge-attachment section 110.

### Technical Advantages of Embodiment

In the ink cartridge 30 according to the above-described embodiment, the electrode group 65 is provided on the top wall 141 of the front cover 32, and the light-blocking plate 62 is provided on the top wall 39 of the rear cover 31. With this configuration, ink is hard to get attached to the electrode group 65 and the light-blocking plate 62 even if ink is leaked from the ink supply portion 34.

Further, since the detection area 63 in the light-blocking plate 62 is positioned further upward relative to the electrode group 65, the electrode group 65 is hard to contact the optical sensors 103 and 113 during the insertion of the ink cartridge 30 into the cartridge-attachment section 110.

Further, the light-blocking plate 62 is positioned closer to the ink supply portion 34 serving as the pivot center of the ink cartridge 30 than the locking surface 151 is to the ink supply portion 34 in the above-described embodiment. Accordingly, the detection area 63 in the light-blocking plate 62 can be ensured to be detected by the optical sensor 103 even if the rear cover 31 and the front cover 32 in the attached state of the ink cartridge 30 are displaced in the up-down direction 53 and 54 or in the left-right direction 55 and 56 about the ink supply portion 34. Further, the light-blocking plate 67 that can be detected by the optical sensor 113 during the attachment of the ink cartridge 30 to the cartridge-attachment section 110 can be provided between the electrode group 65 and the light-blocking plate 62 in the front-rear direction 51 and 52.

Further, when viewed in the left-right direction 55 and 56, the detection area 63 of the light-blocking plate 62 is positioned within the area enclosed by the first imaginary line S1, the second imaginary line S2, and the third imaginary line S3. That is, when viewed in the left-right direction 55 and 56, the detection area 63 is positioned inward of the three portions in the ink cartridge 30 that make physical contact with the components in the cartridge-attachment section 110, i.e., the ink supply portion 34, the electrode group 65, and the locking surface 151. Accordingly, even if the rear cover 31 and the front cover 32 are displaced in the up-down direction 53 and 54 or in the left-right direction 55 and 56 in the attached state of the ink cartridge 30, the detection area 63 of the light-blocking plate 62 can be certainly detected by the optical sensor 103.

Further, since the upper end 62H of the light-blocking plate 62 is positioned further downward relative to the locking surface 151, the light-blocking plate 62 can be suppressed from contacting the locking portion 145 during the attachment of the ink cartridge 30 to the cartridge-attachment section 110.

### Modification

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

FIG. 12 illustrates an ink cartridge 130 according to a first modification to the embodiment. In the first modification, the ink cartridge 130 includes a light-transmissive member 60 that covers the light-blocking plate 62. The light-transmissive member 60 is formed of material that allows the light emitted from the optical sensor 103 to transmit therethrough, and preferably, is transparent. The light-transmissive member 60 has a box-like shape defining therein an internal space so that the light-blocking plate 62 can enter the internal space of the light-transmissive member 60. As the light-transmissive member 60 is placed over the light-blocking plate 62, the left surface 62L, the right surface 62R, the upper end 62H, and a front surface 62F of the light-blocking plate 62 are covered with the light-transmissive member 60. Since a portion of the light-transmissive member 60 is provided at the space 61 between the light-blocking plate 62 and the light-blocking plate 67, the light emitted from the optical sensor 103 passes through the space 61 in the left-right direction 55 and 56 via the light-transmissive member 60.

According to the ink cartridge 130 of the first modification, the light-blocking plate 62 is protected by the light-transmissive member 60. Further, presence of the light-transmissive member 60 can ensure to provide the space 61 between the light-blocking plate 62 and the light-blocking plate 67 in the front-rear direction 51 and 52. With this configuration, even if the light-blocking plate 67 is applied with an external force, for example, the light-blocking plate 67 is hard to be deformed so that the light-blocking plate 67 is positioned at the space 61. Accordingly, each of the light-blocking plate 62 and the light-blocking plate 67 can be certainly detected by the optical sensor 103.

Note that the light-transmissive member 60 may be formed by the inner frame 35. In this case, a portion of the inner frame 35 is arranged to protrude further upward than the top wall 39 of the rear cover 31; and the light-blocking plate 62 is positioned within the internal space of the light-transmissive member 60 as a separate component from the rear cover 31.

Although the locking surface 151 is a surface that faces rearward in the above-described embodiment, another configuration may be employed. FIG. 13 illustrates an ink cartridge 230 according to a second modification of the embodiment. The ink cartridge 230 of the second modification includes a protrusion 243 having a locking surface 251 that faces frontward. The locking surface 251 facing frontward is brought into contact with the locking portion 145 during the insertion of the ink cartridge 230 into the cartridge-attachment section 110, thereby holding the ink cartridge 230 at the attached position.

The light-blocking plate 67 is used to block the light emitted from the optical sensor 113 in the above-described embodiment. That is, the light-blocking plate 67 is provided for the controller of the printer 10 to determine whether the ink cartridge 30 has been completely attached to the cartridge-attachment section 110. However, the light-blocking plate 67 may be provided for the purposes other than that described above. For example, the light-blocking plate 67 may be provided for the controller of the printer 10 to recognize the type of the ink cartridge 30 attached to the cartridge-attachment section 110 (for example, color of ink stored in the ink chamber 36). Alternatively, the light-blocking plate 67 may not be provided in the ink cartridge 30.

The upper end 62H of the light-blocking plate 62 and the first electrode 65A are arranged to intersect the imaginary plane F in the above-described embodiment. However, the upper end 62H of the light-blocking plate 62 and the second electrode 65B may be arranged to intersect the imaginary plane F.

Although ink serves as an example of liquid of the disclosure in the above-described embodiment, the liquid of the disclosure is not limited to ink. For example, a pretreatment liquid that is to be ejected onto sheets prior to ink during a printing operation may be stored in the liquid cartridge of the disclosure. Alternatively, cleaning water for cleaning the recording head 21 may be stored in the liquid cartridge of the disclosure.

<Remarks>

The ink cartridges 30, 130, and 230 are examples of the liquid cartridge. The rear cover 31, the front cover 32, and the inner frame 35 are an example of the cartridge body. The ink chamber 36 is an example of the liquid storage chamber. Ink is an example of the liquid. The ink supply portion 34 is an example of the liquid supply portion. The IC board 64 is an example of the electronic board. The light-blocking plate 62 is an example of the plate. The left surface 62L and the right surface 62R are examples of the attenuating surface. The protrusions 43 and 243 are examples of the positioning member. The locking surfaces 151 and 251 are examples of the positioning surface. The ink supply port 71 is an example of the liquid supply opening. The light-blocking plate 67 is an example of the detection portion. The front cover 32 is an example of the first cover. The rear cover 31 is an example of the second cover. The front wall 40 is an example of the front side. The rear wall 41 is an example of the rear side. The top walls 39 and 141 are examples of an upper side. The bottom walls 42 and 141 are examples of a lower side. The light-blocking plate 67 is also an example of the another plate.

What is claimed is:

1. A liquid cartridge attachable to a case in an attached posture,
the liquid cartridge comprising:
a cartridge body defining therein a liquid storage chamber, the cartridge body having a front surface and a top surface;
a liquid supply portion provided at the front surface of the cartridge body and configured to supply liquid stored in the liquid storage chamber to an outside of the cartridge body;
an electronic board provided at the top surface of the cartridge body and comprising an electrode group comprising at least three electrodes, the at least three electrodes facing upward in the attached posture;
a plate provided at the top surface of the cartridge body, the plate being positioned further rearward relative to the electrode group and protruding further upward relative to the electrode group in the attached posture, the plate having an attenuating surface configured to attenuate incident light traveling in a left-right direction perpendicular to a front-rear direction; and
a positioning member provided at the top surface of the cartridge body, the positioning member being positioned further rearward relative to the plate and protruding upward from the top surface of the cartridge body in the attached posture, the positioning member having a positioning surface for positioning the liquid cartridge attached to the case in the front-rear direction,
wherein when the liquid cartridge is attached to the case, the plate is configured to be detected by an optical sensor configured to emit light traveling in the left-right direction, and
wherein the attenuating surface has a detection area immovable relative to the cartridge body, the light emitted from the optical sensor being configured to be incident on the detection area when the liquid cartridge is attached to the case, the detection area being positioned further rearward and upward relative to the electrode group in the attached posture and positioned further frontward and downward relative to the positioning surface in the attached posture.

2. The liquid cartridge according to claim 1,
wherein in the attached posture, the positioning surface faces rearward.

3. The liquid cartridge according to claim 1,
wherein in the attached posture, the positioning surface faces frontward.

4. The liquid cartridge according to claim 1,
wherein, when viewed in the left-right direction, the detection area is positioned in an area defined by:
a first imaginary line passing through both a center in the front-rear direction of the electrode group and a center in an up-down direction of the positioning surface;
a second imaginary line passing through both a center of a liquid supply opening of the liquid supply portion and the center in the front-rear direction of the electrode group; and
a third imaginary line passing through both the center of the liquid supply opening and the center in the up-down direction of the positioning surface.

5. The liquid cartridge according to claim 1,
wherein the plate has a left end and a right end in the left-right direction positioned further inward relative to a left end and a right end in the left-right direction of the electrode group, respectively.

6. The liquid cartridge according to claim 1,
wherein the plate does not contact the liquid stored in the liquid storage chamber.

7. The liquid cartridge according to claim 1,
wherein the plate is made of resin, the plate and a portion of the cartridge body being formed as a single member, the portion of the cartridge body at least having the top surface of the cartridge body.

8. The liquid cartridge according to claim 1, further comprising a light-transmissive member covering at least the attenuating surface, a front portion, and an upper portion of the plate.

9. The liquid cartridge according to claim 1, further comprising a detection portion provided at the top surface of the cartridge body and configured to attenuate the light emitted from the optical sensor, the detection portion being positioned further rearward relative to the electrode group and further frontward relative to the plate in the attached posture.

10. The liquid cartridge according to claim 1,
wherein in the attached posture, an upper end of the plate is positioned further downward relative to the positioning surface.

11. The liquid cartridge according to claim 1,
wherein the electrode group comprises a first electrode, a second electrode, and a third electrode arranged in the left-right direction such that the third electrode is positioned between the first electrode and the second electrode,
wherein the first electrode, the second electrode, and the third electrode are configured to be electrically connected to the case, and
wherein in the attached posture, an upper end of the plate and one of the first electrode and the second electrode are arranged to intersect an imaginary plane extending both in the front-rear direction and in an up-down direction, the up-down direction crossing both the front-rear direction and the left-right direction.

12. The liquid cartridge according to claim 1,
wherein the cartridge body comprises:
a first cover supporting the electronic board and covering a portion of the liquid storage chamber; and
a second cover comprising the plate and the positioning surface.

13. A liquid cartridge comprising:
a cartridge body defining therein a liquid storage chamber, the cartridge body having a front side, a rear side provided opposite the front side in a front-rear direction, an upper side, and a lower side provided opposite the upper side in an up-down direction which is perpendicular to the front-rear direction;
a liquid supply portion provided at the front side of the cartridge body in the front-rear direction and configured to supply liquid stored in the liquid storage chamber to an outside of the cartridge body;
an electronic board provided at the upper side of the cartridge body in the up-down direction and comprising an electrode group comprising at least three electrodes, the at least three electrodes facing upward in the up-down direction;
a plate configured to attenuate incident light traveling in a left-right direction which is perpendicular to the front-rear direction, the plate being positioned further rearward relative to the electrode group in the front-rear direction and having an upper end protruding further upward relative to the electrode group in the up-down direction; and
a positioning surface provided at the upper side of the cartridge body, the positioning surface being positioned further rearward relative to the plate in the front-rear direction and in the up-down direction,
wherein the upper end of the plate is positioned further rearward and upward relative to the electrode group and positioned further frontward and downward relative to the positioning surface, and
wherein the plate is immovable in the front-rear direction and in the up-down direction relative to the electrode group.

14. The liquid cartridge according to claim 13,
wherein the plate has a rear end and a lower end fixed to the cartridge body.

15. The liquid cartridge according to claim 14,
wherein the positioning surface extends in a direction crossing the front-rear direction, and
wherein the plate is immovable in the front-rear direction and in the up-down direction relative to the positioning surface.

16. The liquid cartridge according to claim 13,
wherein, when viewed in the left-right direction, the plate is positioned in an area defined by:
a first imaginary line passing through both a center in the front-rear direction of the electrode group and a center in the up-down direction of the positioning surface;
a second imaginary line passing through both a center of a liquid supply opening of the liquid supply portion and the center in the front-rear direction of the electrode group; and
a third imaginary line passing through both the center of the liquid supply opening and the center in the up-down direction of the positioning surface.

17. The liquid cartridge according to claim 13,
wherein the plate has a left end and a right end in the left-right direction positioned further inward relative to a left end and a right end in the left-right direction of the electrode group, respectively.

18. The liquid cartridge according to claim 13,
wherein the plate does not contact the liquid stored in the liquid storage chamber.

19. The liquid cartridge according to claim 13, further comprising another plate configured to attenuate incident light traveling in the left-right direction,
wherein the another plate is provided at the upper side of the cartridge body in the up-down direction,
wherein the another plate is positioned further rearward relative to the electrode group and further frontward relative to the plate in the front-rear direction, and
wherein the plate and the another plate are spaced apart from each other in the front-rear direction, and the plate is immovable in the front-rear direction and in the up-down direction relative to the another plate.

20. The liquid cartridge according to claim 13,
wherein the plate has a detection area on which light emitted from an optical sensor and traveling in the left-right direction is incident when the liquid cartridge is attached to a case.
